(19) United States
(12) Patent Application Publication
(10) Pub. No.: US 2026/0121094 A1
(43) Pub. Date: Apr. 30, 2026

(54) Method And Device For Controlling Fuel Cells Using Forward Driving Information Of Fuel Cell Vehicles

(71) Applicants: Hyundai Motor Company, Seoul (KR); Kia Corporation, Seoul (KR)

(72) Inventor: Sang Pil Jang, Hwaseong-Si (KR)

(21) Appl. No.: 19/230,307

(22) Filed: Jun. 6, 2025

(30) Foreign Application Priority Data
Oct. 31, 2024 (KR) 10-2024-0152374

(51) Int. Cl. H01M 8/04858; B60L 50/75; B60L 58/40; H01M 10/48; H01M 16/00

(52) U.S. Cl. CPC H01M 8/0494; B60L 50/75; B60L 58/40; H01M 8/04947; H01M 10/48; H01M 16/006; B60L 2240/642; H01M 2250/20; H01M 2250/402

(57) ABSTRACT

A method for controlling power generation of a fuel cell of a vehicle is disclosed. The method may comprise obtaining driving information about an upcoming segment of a road to be driven by the vehicle driving on a current segment of the road. The method may further comprise determining, based on the driving information, a required fuel cell output value of the current segment. Based on the driving information and the required fuel cell output value, the method may comprise determining whether to limit power generation of the fuel cell. The method may further comprise controlling, based on the determining, reduction of power generation of the fuel cell such that a power supply for driving the vehicle in the current segment is provided from a battery of the vehicle.

### CROSS REFERENCE TO RELATED APPLICATION

The present application claims the benefit of priority to a Korean application 10-2024-0152374, filed in the Korean Intellectual Property Office on Oct. 31, 2024, the entire contents of which are incorporated herein by reference for all purposes.

### FIELD

The present disclosure related to a method and device for controlling a fuel cell by using upcoming driving information of a fuel cell vehicle, and more particularly, to a method and device for controlling a fuel cell by limiting or reducing fuel cell power generation to secure a battery charge SOC before longer than a threshold distance uphill driving and performing electric vehicle (EV) driving in consideration of upcoming driving information acquired from a peripheral device of the vehicle.

### BACKGROUND

The matters described in this Background section are only for enhancement of understanding of the background of the disclosure, and should not be taken as acknowledgment that they correspond to prior art already known to those skilled in the art.

A vehicle (or ‘moving object’) may be controlled depending on a current state of the vehicle and a current driver's will. In a fuel cell power generation control method for a fuel cell electric vehicle (FCEV), an FC power map according to an SOC of a high-voltage battery may be determined by calculating a vehicle output power demand based on a driver's acceleration pedal engagement amount and a service output power of vehicle accessories.

Specifically, a commercial fuel cell vehicle (FCEV) may control fuel cell power generation by calculating a vehicle output power demand based on a driver's acceleration pedal engagement amount and a service output power of vehicle accessories and thus by determining an FC power map according to an SOC of a high-voltage battery. In this case, even if an upcoming driving road to be driven is a longer than a threshold distance and uphill segment or a longer than a threshold distance and downhill segment, as power is generated merely by the FC power map in a current driving segment, there may be a problem in that a battery SOC necessary for the upcoming driving road is not sufficiently secured.

In addition, when an expected battery output value required for an upcoming driving segment is predicted, the expected battery output value is predicted by considering an uphill/downhill change of the upcoming driving segment, and an error may occur and a required battery value may not be accurately calculated.

Thus, a FCEV may not sufficiently secure a battery SOC necessary for an upcoming driving segment because it performs both fuel cell control and battery output even if the upcoming driving segment is longer than a threshold distance and a downhill and battery discharge should be performed in a current driving segment. Accordingly, the performance of the vehicle is degraded during downhill driving, and the speed of the vehicle should be maintained by a driver's use of brake, which increases the wear on the brake pads.

Accordingly, it is desirable to provide a method for determining an expected battery output value for an upcoming driving segment based on information on each segment of an upcoming driving road acquired from a peripheral device of a vehicle and limiting or reducing fuel cell power generation according to the calculated expected battery output value even while the vehicle is operating in a current driving segment.

### SUMMARY

According to the present disclosure, a method for controlling power generation of a fuel cell of a vehicle, the method may comprise obtaining driving information about an upcoming segment of a road to be driven by the vehicle driving on a current segment of the road, determining, based on the driving information, a required fuel cell output value of the current segment, determining, based on the driving information and the required fuel cell output value, whether to limit power generation of the fuel cell, and controlling, based on the determining, reduction of power generation of the fuel cell such that a power supply for driving the vehicle in the current segment is provided from a battery of the vehicle.

The method, wherein the driving information may comprise information about the current segment and the upcoming segment, and wherein the upcoming segment may comprise a first upcoming segment of the road, and a second upcoming segment of the road.

The method, wherein the determining the required fuel cell output value of the current segment may further comprise estimating an expected battery output value, estimating an expected battery charge/discharge energy demand by multiplying the expected battery output value and an expected future driving time for the first upcoming segment and the second upcoming segment, estimating a required battery charge/discharge output value of the current segment by dividing the expected battery charge/discharge energy demand by an expected current driving time for the current segment, and determining the required fuel cell output value of the current driving segment based on a sum of the required battery charge/discharge output value of the current segment and a required vehicle output value for driving of the vehicle.

The method, wherein the determining the required fuel cell output value of the current segment may comprise adjusting the required battery charge/discharge output value based on the required vehicle output value for the driving of the vehicle.

The method, wherein the determining whether to limit power generation of the fuel cell may further comprise determining whether driving the vehicle in the current segment is possible using power supplied solely from the battery by comparing a battery discharge output limit value and a determined electric vehicle (EV) drivable battery discharge output value.

The method may further comprise, based on a determination that the driving the vehicle in the current segment is possible using power supplied solely from the battery, comparing the required fuel cell output value of the current segment and a determined fuel cell power generation demand during the driving of the vehicle.

The method, wherein, based on the required fuel cell output value of the current segment being smaller than the determined fuel cell power generation demand, power generation of the fuel cell is limited while battery discharge occurs for the driving the vehicle in the current segment.

The method, wherein, based on a battery discharge amount for driving the vehicle in the current segment exceeding a predetermined threshold, power generation of the fuel cell is allowed.

The method, wherein, based on the power generation of the fuel cell being limited, the battery is discharged by using power supplied solely from the battery for the driving the vehicle in the current segment, wherein a first upcoming segment of the upcoming segment and a second upcoming segment of the upcoming segment are longer than a threshold distance and a downhill.

The method, wherein, based on the power generation of the fuel cell being allowed, power generation of the fuel cell is controlled for driving the vehicle in the current segment to charge or discharge the battery based on a first upcoming segment of the upcoming segment and a second upcoming segment of the upcoming segment.

According to the present disclosure, an apparatus for controlling power generation of a fuel cell of a vehicle, the apparatus may comprise a peripheral device configured to obtain driving information may comprise at least one of a vehicle speed limit of an upcoming segment of a road to be driven by the vehicle driving on a current segment of the road, or a presence of a gradient and gradient-related data, a processor, and a memory storing at least one instruction that, when executed by the processor, is configured to cause the apparatus to determine, based on the driving information, a required fuel cell output value of the current segment, determine, based on the driving information and the required fuel cell output value of the current segment, whether to limit power generation of the fuel cell, and control, based on the determination, reduction of power generation of the fuel cell such that a power supply for driving the vehicle in the current segment is provided from a battery of the vehicle.

The apparatus, wherein the driving information may comprise information about the current segment and the upcoming segment, and wherein the upcoming segment may comprise a first upcoming segment of the road, and a second upcoming segment of the road.

The apparatus, wherein the at least one instruction, when executed by the processor, is further configured to cause the apparatus to determine the required fuel cell output value of the current segment by estimating an expected battery output value, estimating an expected battery charge/discharge energy demand by multiplying the expected battery output value and an expected future driving time for the first upcoming segment and the second upcoming segment, estimating a required battery charge/discharge output value of the current segment by dividing the expected battery charge/discharge energy demand by an expected current driving time for the current segment, and determine the required fuel cell output value of the current driving segment based on a sum of the required battery charge/discharge output value of the current segment and a required vehicle output value for driving of the vehicle.

The apparatus, wherein the at least one instruction, when executed by the processor, is further configured to cause the apparatus to determine the required fuel cell output value of the current segment by adjusting the required battery charge/discharge output value based on the required vehicle output value for driving of the vehicle.

The apparatus, wherein the at least one instruction, when executed by the processor, is further configured to cause the apparatus to determine whether to limit power generation of the fuel cell by determining whether driving the vehicle in the current segment is possible using power supplied solely from the battery by comparing a battery discharge output limit value and a determined electric vehicle (EV) drivable battery discharge output value.

The apparatus, wherein the at least one instruction, when executed by the processor, is further configured to cause the apparatus to, based on a determination that the driving the vehicle in the current segment is possible using power supplied solely from the battery, compare the required fuel cell output value of the current segment and a determined fuel cell power generation demand during the driving of the vehicle.

The apparatus, wherein the at least one instruction, when executed by the processor, is further configured to cause the apparatus to, based on the required fuel cell output value of the current segment being smaller than the determined fuel cell power generation demand, limit power generation of the fuel cell while battery discharge occurs for the driving the vehicle in the current segment.

The apparatus, wherein the at least one instruction, when executed by the processor, is further configured to cause the apparatus, to allow power generation of the fuel cell based on a battery discharge amount for driving the vehicle in the current segment exceeding a predetermined threshold.

The apparatus, wherein the at least one instruction, when executed by the processor, is further configured to cause the apparatus to, based on the generation of the fuel cell being limited, discharge the battery by using power supplied solely from the battery for the driving the vehicle in the current segment, wherein a first upcoming segment of the upcoming segment and a second upcoming segment of the upcoming segment are longer than a threshold distance and a downhill.

According to the present disclosure, a vehicle may comprise one or more sensors configured to obtain gradient information about an upcoming segment of a road to be driven by the vehicle driving on a current segment of the road, a fuel cell, a battery, a processor, and a memory storing at least one instruction that, when executed by the processor, is configured to cause the vehicle to determine, based on the gradient information, an expected regenerative charging amount of the battery associated with the upcoming segment, determine, based on the expected regenerative charging amount and a required fuel cell output value of the current segment, to limit power generation of the fuel cell, and control, based on the determination to limit power generation of the fuel cell, reduction of power generation of the fuel cell such that a power supply for driving the vehicle in the current segment is provided from the battery while power generation of the fuel cell is limited.

The effects obtainable from the present disclosure are not limited to the above-mentioned effects, and other effects not mentioned herein will be clearly understood by those skilled in the art through the following descriptions.

### BRIEF DESCRIPTION OF THE DRAWINGS

FIG. 1 shows an example of constituent modules of a vehicle equipped with a fuel cell power generation control device according to an example of the present disclosure.

FIG. 2A and FIG. 2B show examples of flowcharts of a method for controlling fuel cell power generation of a vehicle while vehicle drive is performed in a current driving segment according to an example of the present disclosure.

FIG. 3A and FIG. 3B show examples of a predictive battery SOC control process for a vehicle according to a current driving segment and each of at least two or more forwarding driving segments for fuel cell power generation control according to the present disclosure.

FIG. 4 shows an example of an operating mechanism of a fuel cell power generation control device of a vehicle for securing a battery charge SOC before downhill driving according to an example of the present disclosure.

FIG. 5A and FIG. 5B show examples of test data according to whether smart power control is on or off in a current driving segment according to an example of the present disclosure.

### DETAILED DESCRIPTION

Hereinafter, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

Here, electrical devices refer to those related to battery charging and discharging in the vehicle, including a drive motor and a starter generator (HSG) that can charge the battery by converting the braking and inertial energy of the vehicle into electrical energy during regenerative braking or other driving conditions.

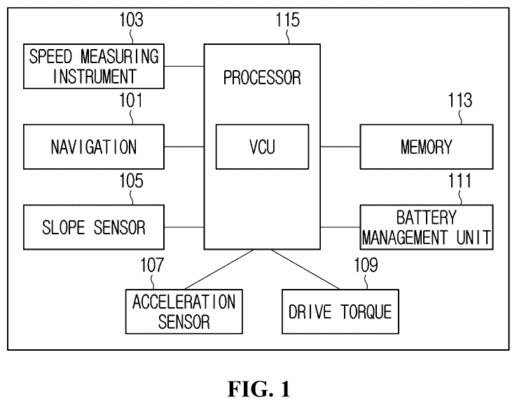

Hereinafter, referring to FIG. 1, a fuel cell power generation control device of a vehicle will be described according to an example of the present disclosure.

FIG. 1 shows an example of constituent modules of a vehicle equipped with a fuel cell power generation control device according to an example of the present disclosure.

A fuel cell power generation control device may be mounted in a hydrogen-powered electric vehicle (e.g., a commercial hydrogen electric vehicle such as a large hydrogen electric truck). A smart power control device may receive information comprising the presence or absence of a road gradient (e.g., incline %) at a predetermined distance ahead of a vehicle, the vehicle's distance and speed limit, real-time traffic conditions. The smart power control device may divide a upcoming driving road into two or more segments, and determine or estimate an expected battery output value (e.g., an expected power requirement) for each segment of the upcoming driving road. Based on the expected battery output value calculated for each segment of the upcoming driving road, even during vehicle drive in a current driving segment (e.g., a downhill), fuel cell power generation may be limited, restricted, reduced, or minimized and only battery output may be used (e.g., during low-speed urban driving, during stop-and-go traffic, or while approaching a designated charging station, etc.).

The fuel cell power generation control device may include a peripheral device, which includes, a navigation unit 101 (e.g., GPS-based system), a speed measuring instrument 103 (e.g., speed sensor), a slope sensor 105, an acceleration sensor 107 and a drive torque 109 (e.g., torque sensor), a battery management unit 111, and a memory 113. The peripheral device is a device for acquiring upcoming driving information of the vehicle and may further include various devices other than the constituent elements shown in FIG. 1. In this regard, the connected car Navigation Cockpit (ccNc) may be provided in (e.g., integrated into) the vehicle and perform a function of acquiring the upcoming driving information. Accordingly, the upcoming driving information according to the present disclosure may be acquired from the ccNc.

The navigation unit 101 may send out road information (e.g., gradients of one or more sections of a road, speed bumps, sharp curves, tunnels, or high-traffic zones, etc.) and/or historical driving route information (e.g., repeated driving route information). Road information may include a vehicle speed limit of an upcoming driving road (may also be referred to as an upcoming section of a road, an upcoming driving section of a road, a forward driving section of a road, a forward driving road, etc.) on which a vehicle is running. Repeated driving route information may be a route registered by a user or an automatically registered route based on driving repeated a predetermined number of times (e.g., past driving behavior repeated over a predetermined number of trips).

Apart from the navigation unit, the battery SOC adjustment device of the vehicle may include, as a peripheral device, the speed measuring instrument 103, the slope sensor 105, the acceleration sensor 107, and the drive torque 109. The speed measuring instrument 103 may measure a driving speed of the vehicle, and the acceleration sensor 107 may measure not only a driving direction of the vehicle (e.g., linear acceleration) but also an acceleration in a different direction (e.g., lateral acceleration, roll, or pitch movements) from the driving direction. In addition, a weight of the vehicle may be determined or estimated using data from the acceleration sensor 107 and the drive torque 109 (e.g., accounting for cargo weight in freight vehicles, number of passengers in buses, or fuel cell stack load variations, etc.).

The battery management unit 111 may play a role to enhance energy efficiency by optimally managing a state of charge (SOC) of a vehicle battery. Such a battery management unit may be implemented as a battery management system (BMS). The battery management unit may monitor the voltage, current and/or temperature of a vehicle battery in real time by using sensors (e.g., an array of sensors). The battery management unit may prevent overcharge and over-discharge of a vehicle battery or thermal runaway through the monitoring. In addition, the battery management unit may determine or estimate a SOC of a vehicle battery (battery SOC) by analyzing current and/or voltage data from sensors. A vehicle battery may supply a power source to an electrical device mounted in a vehicle such as an electronic control unit (ECU) and/or a drive motor (e.g., motor controllers, power steering units, or braking assist systems, etc.).

In addition, the battery management unit may include a battery controller. The battery controller may be a device for monitoring and managing a state of a battery and be used mainly in an electric car or a hybrid vehicle. For a fuel cell control device, the battery controller may calculate a battery discharge output limit value and transmit the battery discharge output limit value to the processor. Herein, the battery discharge output limit value may mean a maximum required battery output value when a vehicle increases its velocity in a current driving segment (e.g., accelerating on highways, during overtaking maneuvers, or while climbing a steep incline, etc.) and performs discharge. Accordingly, the processor may determine whether or not to limit fuel cell power generation by comparing the battery discharge output limit value received from the battery controller and a determined EV drivable battery discharge output value.

The memory 113 may store an application and various types of data for controlling a vehicle and at a request of a processor, load the application or read and record data. The memory may include a non-volatile memory (e.g., SSD, Flash memory, etc.) and a volatile memory (e.g., RAM, cache memory, etc.).

The processor 115 may perform overall control of the vehicle. The processor 115 may have at least one processing module (e.g., circuit, circuitry, application-specific integrated circuits (ASICs)), and each control-related function may be implemented in a single processing module or be implemented in a corresponding processing module among a plurality of modules. In relation to the present disclosure, the processor 115 may control the vehicle to perform fuel cell power generation by using an application, an instruction and data stored in the memory.

Specifically, the processor 115 may acquire upcoming driving information of each segment (e.g., vehicle speed limit, road gradient data, traffic flow information, or upcoming driving distances for each segment). For example, the upcoming driving information may include information on at least one of a vehicle velocity limit on an upcoming driving road, whether the upcoming driving road has a gradient, and a travel distance as upcoming driving information (may also be referred to as forward driving information) of each segment during driving of the vehicle. The processor 115 may determine or estimate a total amount of expected battery output energy (e.g., for each segment) based on the acquired upcoming driving information of each segment. In addition, the processor 115 may determine a fuel cell power generation output value in a current driving segment in order to charge or discharge a battery based on the total amount of expected battery output energy,

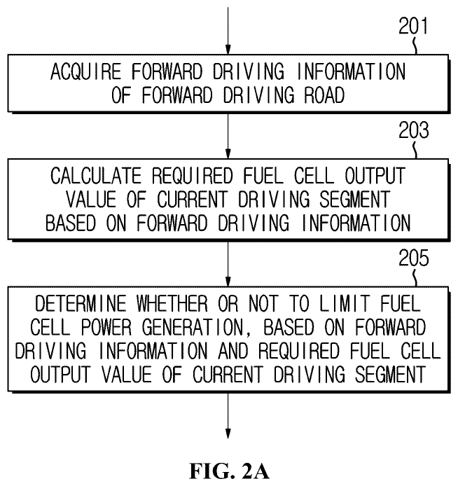

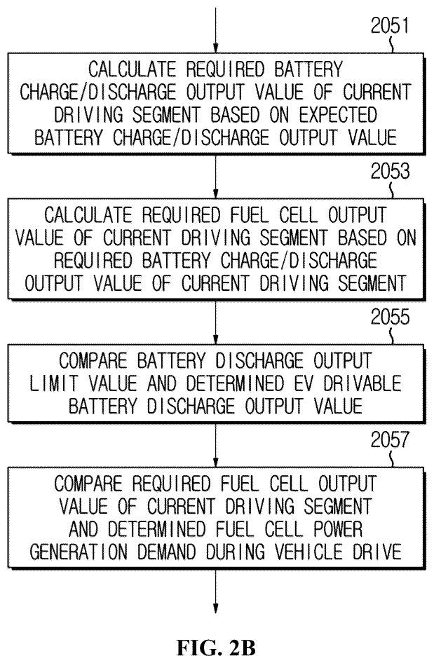

The battery SOC adjustment device of the vehicle according to the present disclosure may be a device configured to implement processing of adjustment of a battery SOC demand value through a processor by including at least the speed measuring instrument 103 (e.g., speed sensor), the navigation unit 101, the slope sensor 105, the acceleration sensor 107, the drive torque 109, the memory 113, the battery management unit 111 and the processor 115. The processing may be implemented by at least a portion of the processor such as at least one processing module that may function as a Vehicle Control Unit (VCU). The above-described processing of the processor will be described in detail through FIG. 2.

FIG. 2A and FIG. 2B show examples of flowcharts of a method for controlling fuel cell power generation of a vehicle while the vehicle is operating (e.g., driving) in a current driving segment according to an example of the present disclosure.

Referring to FIG. 2A, a method for controlling fuel cell power generation of a vehicle according to the present disclosure may include acquiring upcoming driving information (e.g., predictive driving data) of an upcoming driving road (201), calculating a required fuel cell output value of a current driving segment based on the upcoming driving information (203), determining whether or not to limit fuel cell power generation, based on the upcoming driving information and the required fuel cell output value of the current driving segment (205), when an upcoming driving segment is longer than a threshold distance and a downhill, performing vehicle drive in the current driving segment by limiting fuel cell power generation and using only a battery output (207).

First, according to step S201, the acquiring of the upcoming driving information of the upcoming driving road is performed by peripheral devices (e.g., vehicle-integrated sensors) of the vehicle or communicating with external data sources.

For example, the navigation unit 101 may provide information on operating conditions of a vehicle (e.g., posted speed limits, historical traffic patterns, elevation maps, or route curvature details for each upcoming road segment, for example, whether the road includes inclines, descents, or continuous rolling terrain, etc.) The information may include a vehicle speed limit according to each segment of an upcoming driving road, a driving distance of a vehicle according to each upcoming driving segment, whether the upcoming driving road has a gradient in each segment, and an angle of a gradient. A velocity measuring instrument may provide a current driving velocity (e.g., a speed and a direction) of the vehicle. A slope sensor may provide information regarding whether there is a gradient in a current driving segment on which a vehicle is running, and an angle. An acceleration sensor and a drive torque may provide information necessary to determine or estimate a weight of a vehicle, factoring in load variations (e.g., cargo weight for freight trucks, passenger occupancy for buses, or payload conditions for utility vehicles, etc.).

The processor 115 may determine or estimate an expected battery output value by receiving, as inputs, information on an upcoming driving segment (e.g., whether there is a gradient, a driving distance, and a velocity limit of the vehicle) from peripheral devices. The processor 115 may determine, based on the inputs, the energy requirements of the upcoming driving segment. The processor 115 may further determine, based on the energy requirements of the upcoming driving segment, whether or not to limit fuel cell power generation, when the vehicle is being driven in a current driving segment. Herein, when the vehicle is being driven, it may mean acceleration or deceleration phases, and the upcoming driving segment may be divided into at least two or more segments, that is, a first upcoming driving segment and a second upcoming driving segment.

According to step S203, the determining the required fuel cell output value for the current driving segment is based on the upcoming driving information. The determining the required fuel cell output value for the current driving segment may involve a step at which a required battery charge/discharge output value and a current required vehicle output value are added based on information acquired from peripheral devices of the vehicle.

The required battery charge/discharge output value of the current driving segment may be obtained by dividing an expected battery energy demand by a driving time of the current driving segment (e.g., an expected duration of driving through the current driving segment). The expected battery charge/discharge energy demand may be obtained by multiplying an expected battery output value and a future driving time. For example, the expected battery output value may be an expected battery discharge output value when the first upcoming driving segment and the second upcoming driving segment are longer than a threshold distance and an uphill (an uphill road) (e.g., prolonged uphill driving in mountainous areas, ascending highway ramps, or long urban overpasses, etc.). For example, the expected battery output value may be may be an expected battery charge output value when the first upcoming driving segment and the second upcoming driving segment are longer than a threshold distance and a downhill (a downhill road) (e.g., highway downhill stretches, mountain descent roads, or regenerative braking zones in urban areas, etc.).

According to step S205, the determining of whether or not to limit fuel cell power generation based on the upcoming driving information and the required fuel cell output value of the current driving segment may be performed through a fuel cell power generation control process based on an expected battery SOC change according to the first upcoming driving segment and the second upcoming driving segment. If the upcoming driving segment is longer than a threshold distance and a downhill, when the vehicle is driven in the current driving segment, fuel cell power generation may be limited, restricted, reduced, or minimized and only battery output may be used (e.g., switching vehicle operation to battery-only mode) so that a battery SOC may be discharged in advance deliberately to be charged by regenerative braking during upcoming downhill driving. That is, the vehicle drive in the current driving segment may be performed, for example, in a battery-only mode to intentionally discharge the battery to reduce the battery SOC before entering an expected or predicted regenerative braking phrase of the first upcoming driving segment and the second upcoming driving segment that are longer than a threshold distance and a downhill. By reducing the battery SOC in the current segment of the road, the regenerative braking in the upcoming driving segment may increase the reduced battery SOC to a level that does not exceed a threshold battery SOC (e.g., such that that increased battery SOC does not exceed the threshold battery SOC (e.g., 85%, 90%, 90%, 95%, etc.))

Referring to FIG. 2B, according to step S205, the performing of vehicle drive in the current driving segment by limiting fuel cell power generation and using only battery output based on the upcoming driving segment being longer than a threshold distance and a downhill may comprise the following steps:
determining or estimating a required battery charge/discharge output value of the current driving segment based on the expected battery charge/discharge output value (2051),
determining or estimating a required fuel cell output value of the current driving segment based on the required battery charge/discharge output value of the current driving segment (2053),
comparing a battery discharge output limit value and a determined EV drivable battery discharge output value (2055), and
comparing the required fuel cell output value of the current driving segment and a determined fuel cell power generation demand during vehicle drive (2057).

According to FIG. 2B, first, step S205 includes determining or estimating, according to step S2051, the required battery charge/discharge output value of the current driving segment based on the expected battery charge/discharge output value. In order to obtain the required battery charge/discharge output value, both an expected battery charge/discharge energy amount and the expected battery charge/discharge output value are considered.

As the expected battery charge/discharge energy amount may be obtained by multiplying the expected battery charge/discharge output value and an expected future driving time, the expected battery output value may be obtained by a VCU through a vehicle dynamics equation. For example, the vehicle dynamics equation may be Equation 1 below.

$${F}_{traction} = ( {F}_{drag} + {F}_{roll} + {F}_{grade} ) = 0.5 * ρ * {C}_{d} * A * {V}^{2} + mg * ( {C}_{r} cos θ + sin θ ) \qquad [ Equation 1 ]$$

Here, F_{traction} is a traction force, F_{drag} is air drag, Fᵣₒₗₗ is rolling resistance, and F_{grade} is gradability. m is a vehicle mass, g is the acceleration of gravity, p is air density, Cd is an air resistance coefficient, A is a front area, and Cr is a rolling resistance coefficient.

Specifically, in case a navigation unit detects that a first upcoming driving road and a second upcoming driving road are longer than a threshold distance and an uphill, an expected battery discharge output value may be obtained by multiplying a battery efficiency and a difference between an expected fuel cell power generation output value and an expected gradient driving output value. On the other hand, in case the navigation unit detects that the first upcoming driving road and the second upcoming driving road are longer than a threshold distance and a downhill, an expected battery charge output value may be determined by dividing an expected gradient driving output value by a battery efficiency.

Next, according to step S2053, the determining the required fuel cell output value of the current driving segment may be determined by adding a current required vehicle output value to the required battery charge/discharge output value of the current driving segment obtained through step S2053. Herein, the required vehicle output value may be calculated based on a driver's acceleration pedal engagement amount and a service output power of vehicle accessories in a fuel cell vehicle.

Next, according to step S2055, the comparing the battery discharge output limit value and the determined EV drivable battery discharge output value may determine, based on expected battery output values determined in the first upcoming driving segment and the second upcoming driving segment, whether or not motor drive is possible only by battery output because the battery discharge limit value is sufficient even during vehicle drive in the current driving segment.

If the battery discharge output limit value is greater than the determined EV drivable battery discharge output value, step S2057, comparing of the required fuel cell output value of the current driving segment and the determined fuel cell power generation demand during vehicle drive may be performed to determine whether or not to limit fuel cell power generation during vehicle drive in the current driving segment. On the other hand, if the determined EV drivable battery discharge output value is greater than the battery discharge output limit value, fuel cell power generation may not be limited, restricted, reduced, or minimized during vehicle drive in the current driving segment or driving the vehicle in the current driving segment. Thus, a required battery SOC for an upcoming driving segment may be charged or discharged in advance by controlling fuel cell power generation.

Next, according to step S2057, the comparing the required fuel cell output value of the current driving segment and the determined fuel cell power generation demand during vehicle drive may be performed to secure a required battery output value when the first upcoming driving segment and the second upcoming driving segment are downhill and battery charge by regenerative braking is expected. If vehicle is driven in the current driving segment, and the battery can solely power the motor without support from the fuel cell (e.g., the battery discharge limit value is so sufficient that motor drive is possible only with battery output), fuel cell power generation may be limited, restricted, reduced, or minimized to use a sufficient battery SOC (e.g., allowing battery-only operation to ensure a maximum battery utilization for the expected regenerative braking during the upcoming downhill).

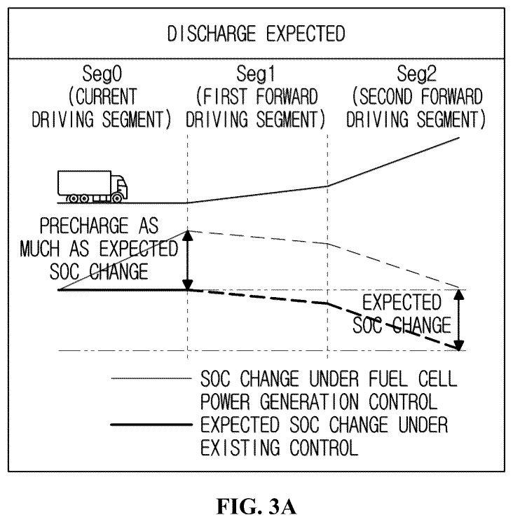

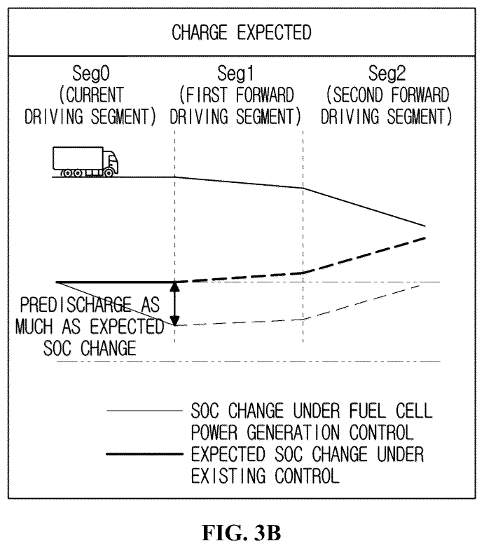

FIG. 3A and FIG. 3B show examples of a predictive battery SOC control process for a vehicle according to a current driving segment and at least two or more upcoming driving segments for fuel cell power generation control according to another example of the present disclosure. The processor 115 may dynamically adjust fuel cell power generation based on upcoming road conditions. For uphill driving, the processor 115 may pre-charge the battery to prepare for increased power demand. For downhill driving, the processor may discharge excess SOC to increase or maximize regenerative braking efficiency. With the predictive battery SOC control process, the fuel cell power of a vehicle may be managed effectively to prevent SOC depletion during driving of the vehicle over extended inclines, SOC overcharging during driving of the vehicle over extended descents, increase energy efficiency, extend battery lifespan, or reduce dependency on mechanical braking, reducing brake wear and tear.

Referring to FIG. 3A and FIG. 3B, the determining the required fuel cell output value of the current driving segment at step S201 and step S203 may be described. That is, according to the present disclosure, an expected battery SOC change may be predicted based on road gradient data and its degree of inclination for each upcoming driving segment (e.g., whether each of an upcoming driving road has a gradient and a degree thereof). Accordingly, the expected battery SOC change may be converted into a required battery charge/discharge output value in a current driving segment and thus fuel cell power generation output may be controlled, and a required fuel cell output value of the current driving segment may be determined or estimated.

Specifically, FIG. 3A is a fuel cell power generation control process when a first upcoming driving segment and a second upcoming driving segment are longer than a threshold distance and an uphill and an expected battery output value is expected to be discharged. First, in order to obtain a required battery charge output value of a current driving segment, an expected battery charge output value of each segment may be calculated when the first upcoming driving segment and the second upcoming driving segment are longer than a threshold distance and an uphill. The expected battery charge output value of each upcoming driving segment may be an expected gradient driving output value during regenerative braking. The required battery charge output value of the current segment may be obtained by dividing the expected battery charge output value of each upcoming driving segment by an expected current driving time.

For example, in FIG. 3A, a driving segment is divided into a current driving segment (Seg 0), a first upcoming driving segment (Seg 1), and a second upcoming driving segment (Seg 2). In the current driving segment Seg 0, an expected amount of battery SOC change may be determined or estimated for the first upcoming driving segment and the second upcoming driving segment of a vehicle, and charge may be performed in advance (e.g., ensuring sufficient energy reserved for uphill driving).

For example, in a fuel cell control method, an amount of battery SOC change may not be maintained or actively managed but have a value below a preset reference point, and thus discharge may occur. Specifically, the first driving segment (Seg 1) is a longer than a threshold distance and a uphill with a gradient less than a threshold gradient, on which a battery SOC value is discharged less than a threshold discharge amount at the preset reference point, and the second driving segment (Seg 2) is a longer than a threshold distance and an uphill with a gradient more than a threshold gradient, on which the battery SOC value may be discharged more than a threshold discharge amount at the preset reference point than in the first driving segment 1. Thus, the fuel cell control method without active management of the battery SOC change, the SOC may be depleted below a predefined minimum threshold, leading to unexpected power limitations during an uphill driving.

On the other hand, in case fuel cell power control is performed with active management, since charge may be performed in a current driving segment as much as an amount of battery SOC change, even driving on a longer than a threshold distance and an uphill may not cause a battery SOC value to be lowered below a preset reference value. A required battery charge energy amount may be determined by multiplying the determined expected battery charge output value of the upcoming driving segment and an expected future driving time (e.g., estimated driving duration). A required battery charge value of the current driving segment may be obtained by dividing the required battery charge energy amount over time (e.g., estimated driving duration). Finally, a required fuel cell output value of the current driving segment may be determined by adding the required battery charge value of the current driving segment and a required vehicle output value.

FIG. 3B is a fuel cell power generation control process when a first upcoming driving segment and a second upcoming driving segment are longer than a threshold distance and a downhill and a battery SOC value is expected to be charged. In order to obtain a required battery charge output value of a current driving segment, an expected battery discharge output value of each segment may be determined when the first upcoming driving segment and the second upcoming driving segment are longer than a threshold distance and a downhill. The expected battery discharge output value of each segment may be determined by subtracting an expected fuel cell power generation value from an expected gradient driving output value, when a moving object (e.g., a vehicle) is being driven. The required battery charge output value of the current segment may be obtained by dividing the expected battery discharge output value of each segment by an expected driving time of the current segment.

For example, in FIG. 3B, a driving segment is divided into a current driving segment (Seg 0), a first driving segment (Seg 1), and a second driving segment (Seg 2). In the current driving segment (Seg 0), an expected amount of battery SOC change may be determined for the first upcoming driving segment (Seg 1) and the second upcoming driving segment (Seg 2) of a vehicle, and discharge may be performed in advance (e.g., preemptively discharging excess SOC to make capacity for regenerative braking).

For example, in a control method, an amount of battery SOC change may not be maintained or actively managed but have a value exceeding a preset reference point, and thus overcharge may occur. Specifically, the first driving segment (Seg 1) is a longer than a threshold distance and a downhill with a gradient less than a threshold gradient, on which a battery SOC value is charged less than a threshold charge amount at the preset reference point, and the second driving segment (Seg 2) is a longer than a threshold distance and a downhill with a gradient more than a threshold gradient, on which the battery SOC value may be charged more than a threshold charge amount at the preset reference point than in the first driving segment 1. Thus, the control method without active management of the battery SOC change, the SOC may exceed a predefined maximum threshold during a downhill driving, leading to wasted regenerative braking energy and excessive braking wear.

On the other hand, in the case of a battery SOC adjustment device that performs fuel cell power control, since discharge may be performed in a current driving segment as much as an amount of battery SOC change, even driving on a longer than a threshold distance and a downhill may not cause a battery SOC value to exceed a preset reference value (e.g., battery SOC is preemptively discharged in the current driving segment, preventing overcharging or excessive energy dissipation). A required battery discharge energy amount may be determined by multiplying the determined expected battery discharge output value of the upcoming driving segment and an expected future driving time (e.g., estimated duration of driving). A required battery discharge value of the current driving segment may be obtained by dividing the required battery discharge energy amount by an expected current driving time. Finally, a required fuel cell output value of the current driving segment may be determined by adding the required battery discharge value of the current driving segment and a required vehicle output value.

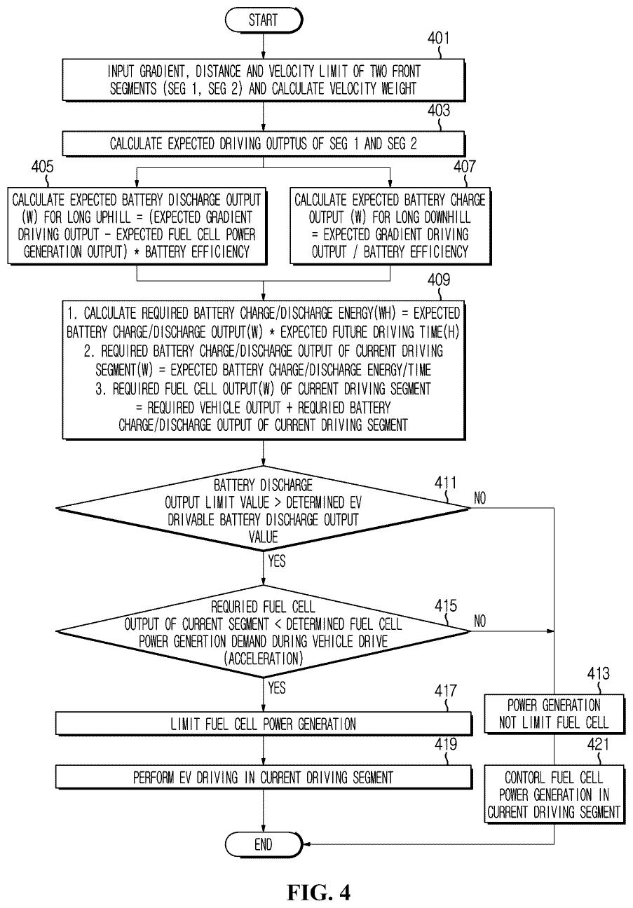

FIG. 4 shows an example of an operating mechanism of a fuel cell power generation control device of a vehicle for securing a battery charge SOC before entering a downhill driving segment according to an example of the present disclosure.

Referring to FIG. 4, a method for controlling fuel cell power generation of a vehicle may calculate an expected battery charge/discharge output value for a first upcoming driving segment and a second upcoming driving segment and operate a motor of the vehicle using only battery power (e.g., using only by a battery output) even while the vehicle is operating in a current driving segment. That is, fuel cell power generation may be limited, restricted, reduced, or minimized to increase or maximize battery utilization before entering the downhill driving segment.

Referring to FIG. 4, when the vehicle is operating (e.g., driving) in the current driving segment, a process of controlling fuel cell power generation may be described as follows. First, the battery SOC adjustment device may be initiated by receiving, as inputs (e.g., real-time data inputs), information on whether two or more distinguished upcoming driving segments to be covered in the future have a gradient, a driving distance of each segment and a speed limit of a vehicle may be received from a peripheral device of the vehicle and receiving a weight of the vehicle from a vehicle acceleration sensor and a drive torque (401). For example, the peripheral device of the vehicle may be the above-described ccNc or other telematics-based control circuits.

Next, expected gradient driving output values (e.g., expected gradient driving power demand) of a first upcoming driving segment (Seg 1) and a second upcoming driving segment (Seg 2) may be determined by a vehicle dynamics equation as expressed by Equation 1 above (403). Herein, the expected gradient driving output value may be an expected battery output value. For example, the expected gradient driving output value may be used to estimate the battery charge or discharge behavior required for upcoming inclines or declines and determine battery charge or discharge strategy.

Herein, in case an upcoming driving segment is longer than a threshold distance and an uphill, the expected battery output value may be an expected battery discharge output value, which may be determined by multiplying battery efficiency and the difference between an expected fuel cell power generation output value and the expected gradient driving output value (405). On the other hand, in case the upcoming driving segment is longer than a threshold distance and a downhill, the expected battery output value may be an expected battery charge output value, which may be determined by dividing the expected gradient driving output value by battery efficiency (407).

Next, at step S409, in order to obtain a required fuel cell output value of a current driving segment, a required battery charge/discharge energy amount and a required battery charge/discharge output value of the current driving segment may be determined (409). The required fuel cell output value of the current driving segment may be determined by adding a required vehicle output value and the required battery charge/discharge output value of the current driving segment. Herein, the required battery charge/discharge output value of the current driving segment may be obtained by dividing an expected battery charge/discharge energy amount by an expected current driving time. The expected battery charge/discharge energy amount may be obtained by multiplying the expected battery charge/discharge output value and an expected future driving time.

Next, it is possible to compare a battery discharge output limit value, which is expected based on a battery discharge output value obtained at step S409 and when the first upcoming driving segment and the second upcoming driving segment are downhill, and a EV drivable battery discharge output value (411). If the battery discharge output limit is greater than the EV-drivable battery discharge value, the vehicle may operate on battery power alone, and fuel cell power generation is restricted. This may ensure efficient battery utilization before entering a downhill segment, where regenerative braking will naturally replenish SOC. If the EV-drivable battery discharge value is greater than the battery discharge output limit, fuel cell power generation is not restricted (e.g., may be maintained), as additional energy is required for operation of the vehicle.

A fuel cell vehicle, not implementing the features of the present disclosure, may accelerate by maintaining fuel cell power generation and using a battery output together to supply power to a drive motor, even if a battery discharge output limit value is sufficient. On the other hand, in the present disclosure, if the battery discharge output limit value is greater, it may be determined that vehicle is able to operate battery power alone in a current driving segment because expected battery discharge limit values are sufficient in the first upcoming driving segment and the second upcoming driving segment. Accordingly, step S411 may be performed to determine whether or not to limit fuel cell power generation to sufficiently use a battery SOC even while the vehicle is operating in the current driving segment.

Herein, the determined EV drivable battery discharge output value may be a criterion for determining whether or not a battery SOC should be discharged in advance by using forwarding information acquired a peripheral device such as ccNc because the first upcoming driving segment and the second upcoming driving segment are longer than a threshold distance and a downhill (a downhill road). That is, a battery SOC, which may be output by limiting fuel cell power generation and perform EV driving, may mean a discharge value. EV driving may be a case in which an electric vehicle is driven only by a battery output and a motor of the vehicle is driven by using electricity stored in the battery.

At step S411, if the determined EV drivable battery discharge output value is greater than the battery discharge output limit value, fuel cell power generation may not be limited, restricted, reduced, or minimized (413). For example, the battery SOC may be actively controlled to regulate charge and discharge rates to ensure efficient SOC levels before entering downhill driving segments. That is, during vehicle drive in the current driving segment, fuel cell power generation may be controlled to charge or discharge a battery SOC in advance according to a required battery SOC for the first upcoming driving segment and the second upcoming driving segment (421). On the other hand, if the battery discharge output limit value is greater than the determined EV drivable battery discharge output value, a required fuel cell output value of the current driving segment may be compared with a determined fuel cell power generation demand during vehicle operation (415).

If the required fuel cell output value of the current driving segment is smaller than the determined fuel cell power generation demand during vehicle drive, fuel cell power generation may be limited, restricted, reduced, or minimized (417) (e.g., performing EV driving using only a battery output during vehicle drive in the current driving segment). This may ensure that a battery SOC is sufficiently discharged to allow for increased or maximum regenerative braking efficiency when driving downhill (e.g., as the first upcoming driving segment and the second upcoming driving segment are predicted to be longer than a threshold distance and a downhill (419)). On the other hand, if the determined fuel cell power generation demand during vehicle drive is smaller than the required fuel cell output value of the current driving segment, fuel cell power generation may not be limited, restricted, reduced, or minimized (413). That is, during vehicle drive in the current driving segment, fuel cell power generation may be controlled to charge or discharge a battery SOC in advance according to a required battery SOC for the first upcoming driving segment and the second upcoming driving segment (421). At Step 421, a battery management system may actively adjust fuel cell power generation to regulate SOC levels dynamically, ensuring that the vehicle maintains energy efficiency throughout both uphill and downhill driving conditions.

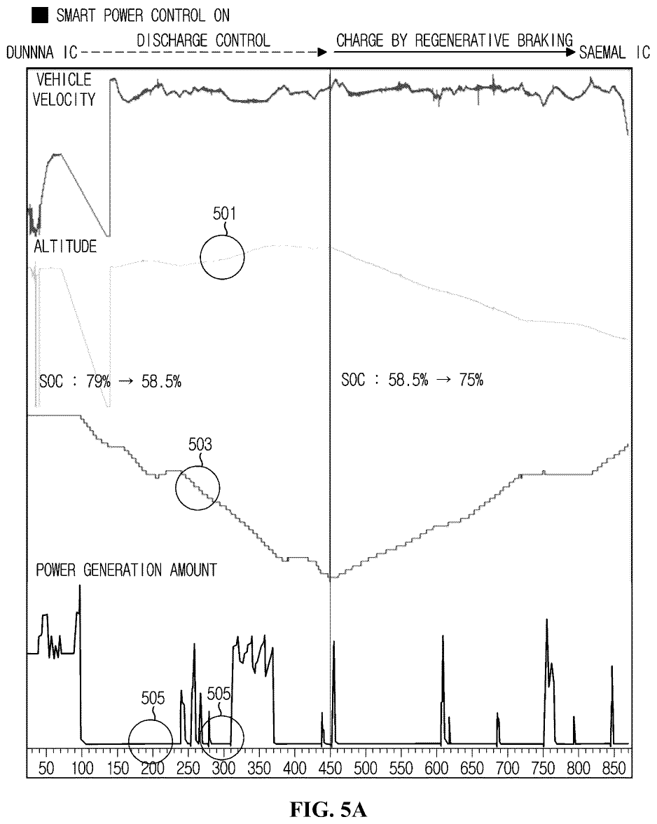

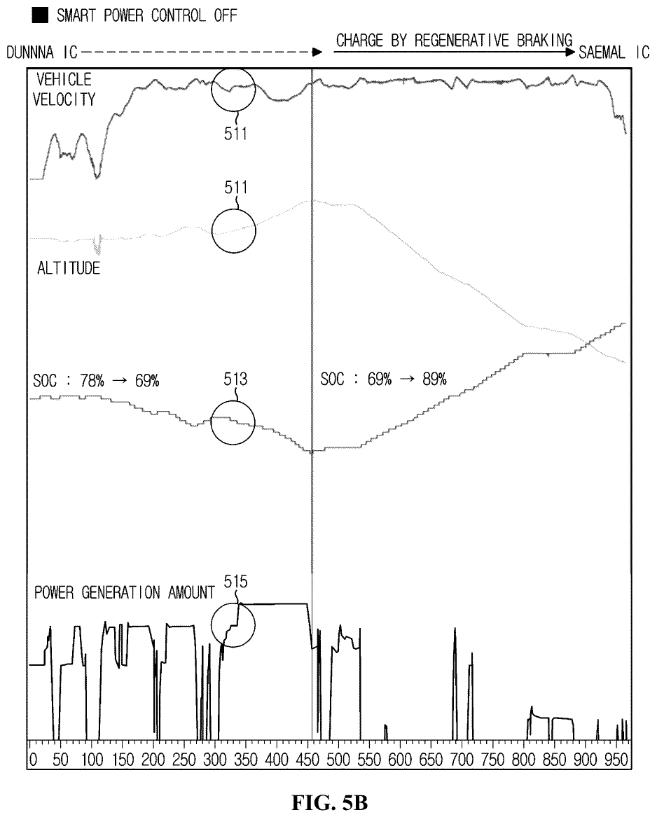

FIG. 5A and FIG. 5B show examples of test data according to whether smart power control is enabled vs. disabled in a current driving segment according to an example of the present disclosure.

Referring to FIG. 5A and FIG. 5B, a method for controlling a fuel cell of a vehicle according to the present disclosure may reduce an overall fuel cell power generation amount by limiting fuel cell power generation before an upcoming driving segment, which is longer than a threshold distance and a downhill (a downhill road). The method also may maintain regenerative braking for a longer time than a threshold time during the longer downhill driving by discharging a required battery SOC for the longer downhill driving beforehand. By discharging the required battery SOC beforehand, regenerative braking is sustained for a longer duration when the vehicle enters a downhill driving segment that exceeds a predefined threshold distance.

Specifically, FIG. 5A is a smart power control process in which a vehicle limits fuel cell power generation and operates solely on a battery output in the current driving segment. Herein, if the vehicle is driven slightly uphill (e.g., uphill with a gradient less than a threshold gradient) at an altitude of a current driving segment (501), only a battery output may be used during vehicle drive in the current driving segment so that a battery SOC may be sufficiently discharged in advance because it will be charged by regenerative braking in an upcoming driving segment that is predicted to be longer than a threshold distance and a downhill (503). Accordingly, in order to sufficiently use the battery SOC in the current driving segment, fuel cell power generation may be limited, restricted, reduced, or minimized by determining whether or not EV driving is possible (505). This ensures that the battery may effectively store energy recovered during the upcoming downhill driving segment. For example, in FIG. 5A, a longer than a threshold distance and downhill segment is predicted through an altitude graph of an upcoming driving segment (501). Accordingly, as fuel cell power generation is limited, restricted, reduced, or minimized in the current driving segment, a power generation amount may have a value of 0 in the graph (505), and driving only by a battery output may result in sufficient use of a battery SOC value from 79% to 58.5% (503). Because of EV driving with limited fuel cell power generation, the battery SOC may be charged from 58.5% up to 75% by regenerative braking during driving on the upcoming driving segment that is downhill.

On the other hand, FIG. 5B is a graph showing a process of performing fuel cell power generation together with a battery output, in which smart power control is not enabled. If the vehicle is driven slightly uphill (e.g., uphill with a gradient less than a threshold gradient) at an altitude of a current driving segment (511), a battery output may be used together during vehicle drive in the current driving segment, while fuel cell power generation is maintained, and thus a battery SOC may not be sufficiently used up because it will be charged by regenerative braking in an upcoming driving segment that is predicted to be longer than a threshold distance and a downhill (513). As smart power control is not enabled to limit fuel cell power generation, even though a battery SOC is expected to be charged by regenerative braking in an upcoming driving segment that is predicted to be longer than a threshold distance and a downhill, the vehicle may keep operating by maintaining fuel cell power generation (515). For example, in the case of FIG. 5B, even if a longer than a threshold distance and downhill segment is predicted based on the altitude graph of the upcoming driving segment, fuel cell power generation is controlled, and thus a power generation amount may constantly occur on the graph (515). Since the battery SOC reaches its upper limit too soon, excess regenerative energy cannot be stored, resulting in wasted energy. That is, in case smart power control is not enabled, a battery SOC is already high at the start point of the upcoming driving segment that is longer than a threshold distance and a downhill, and the battery SOC may have been charged up to a limit value before the longer downhill driving is completed. Further, as a driver should maintain a vehicle speed by using a main brake (e.g., a mechanical braking), the performance of the vehicle may be degraded for longer than a threshold distance downhill driving and other problems may also occur including increased wear on brake pads. Herein, the power generation amount is a value indicating a fuel cell power generation amount, which may mean an amount of power generated by a fuel cell in a fuel cell vehicle, that is, a hydrogen fuel cell vehicle. A fuel cell may consist of a single cell, or a plurality of fuel cells may constitute a stack.

The present disclosure is technically directed to providing a method and device for controlling fuel cell power generation of a vehicle by efficiently controlling a battery charge/discharge output value based on information on each segment of an upcoming driving road acquired from a peripheral device of the vehicle.

In addition, in order to solve the technical problem of the present disclosure, the present disclosure is directed to providing a method and device for controlling a fuel cell by dividing a driving road of a vehicle into segments and limiting fuel cell power generation according to an expected battery output value for a front segment even while the vehicle is operating in a current driving segment.

The technical problems solved by the present disclosure are not limited to the above technical problems and other technical problems which are not described herein will be clearly understood by a person having ordinary skill in the technical field, to which the present disclosure belongs, from the following description.

According to the present disclosure, a method is provided for controlling fuel cell power generation of a vehicle. The method may comprising: acquiring upcoming driving information of an upcoming driving road; calculating a required fuel cell output value of a current driving segment based on the upcoming driving information; determining whether or not to limit fuel cell power generation, based on the upcoming driving information and the required fuel cell output value of the current driving segment, wherein based on an upcoming driving segment being longer than a threshold distance and a downhill, the fuel cell power generation is limited, and vehicle drive is performed in the current driving segment by using only a battery output.

According to an example of the method of the present disclosure, the method of claim 1, wherein the upcoming driving information is acquired according to each upcoming driving segment that is distinguished into including the current driving segment, a first upcoming driving segment and a second upcoming driving segment.

According to an example of the method of the present disclosure, the method of claim 2, wherein the calculating of the required fuel cell output value of the current driving segment further comprises: calculating an expected battery output value; calculating an expected battery charge/discharge energy demand by multiplying the expected battery output value and an expected future driving time; calculating a required battery charge/discharge output value of the current driving segment by dividing the expected battery charge/discharge energy demand by an expected current driving time; and determining the required fuel cell output value of the current driving segment by adding the required battery charge/discharge output value of the current driving segment and a required vehicle output value.

According to an example of the method of the present disclosure, the method of claim 3, further comprising determining a required fuel cell output value of the current driving segment by correcting the required battery charge/discharge output value by a required vehicle output value for driving, wherein the required fuel cell output value of the current driving segment is determined by adding the required vehicle output value to the required battery charge/discharge output value.

According to an example of the method of the present disclosure, the method of claim 1, wherein the determining of whether or not to limit the fuel cell power generation further comprises determining whether or not vehicle drive is possible by using only a battery output, by comparing a battery discharge output limit value and a determined EV drivable battery discharge output value.

According to an example of the method of the present disclosure, the method of claim 5, further comprising, based on the vehicle drive being determined to be possible by using only the battery output in the current driving segment, comparing the required fuel cell output value of the current driving segment and a determined fuel cell power generation demand during the vehicle drive.

According to an example of the method of the present disclosure, the method of claim 6, wherein the fuel cell power generation is not limited when the battery discharge of the vehicle in the current driving segment is performed up to or above a predetermined criterion.

According to an example of the method of the present disclosure, the method of claim 7, wherein based on the fuel cell power generation being limited, a battery SOC is discharged by using only the battery output during the vehicle drive in the current driving segment, even if the first upcoming driving segment and the second upcoming driving segment are longer than a threshold distance and a downhill.

According to an example of the method of the present disclosure, the method of claim 8, wherein based on the fuel cell power generation not being limited, the fuel cell power generation is controlled during the vehicle drive in the current driving segment to charge or discharge the battery SOC according to the first upcoming driving segment and the second upcoming driving segment.

According to another example of the present disclosure, a device is provided controlling fuel cell power generation of a vehicle by controlling a battery output value through upcoming driving information. The device may comprising: a peripheral device configured to acquire at least one or more of a vehicle velocity limit of an upcoming driving road, whether there is a gradient and gradient data as upcoming driving information; a memory configured to store at least one instruction: and a processor configured to execute the at least one instruction stored in the memory, wherein the processor is further configured to: calculate a required fuel cell output value of a current driving segment based on the upcoming driving information, and determine whether or not to limit fuel cell power generation, based on the upcoming driving information and the required fuel cell output value of the current driving segment, and wherein based on an upcoming driving segment being longer than a threshold distance and a downhill, the fuel cell power generation is limited, and vehicle drive is performed in the current driving segment by using only a battery output.

According to an example of the device of the present disclosure, the device of claim 11, wherein the upcoming driving information is acquired according to each upcoming driving segment that is distinguished into including the current driving segment, a first upcoming driving segment and a second upcoming driving segment.

According to an example of the device of the present disclosure, the device of claim 12, wherein the processor is further configured to: in order to calculate the required fuel cell output value of the current driving segment, calculate an expected battery output value, calculate an expected battery charge/discharge energy demand by multiplying the expected battery output value and an expected future driving time, calculate a required battery charge/discharge output value of the current driving segment by dividing the expected battery charge/discharge energy demand by an expected current driving time, and determine the required fuel cell output value of the current driving segment by adding the required battery charge/discharge output value of the current driving segment and a required vehicle output value.

According to an example of the device of the present disclosure, the device of claim 13, wherein the processor is further configured to determine a required fuel cell output value of the current driving segment by correcting the required battery charge/discharge output value by a required vehicle output value for driving, and wherein the required fuel cell output value of the current driving segment is determined by adding the required vehicle output value to the required battery charge/discharge output value.

According to an example of the device of the present disclosure, the device of claim 11, wherein the processor is further configured to, when determining whether or not to limit the fuel cell power generation, determine whether or not vehicle drive is possible by using only a battery output by comparing a battery discharge output limit value and a determined EV drivable battery discharge output value.

According to an example of the device of the present disclosure, the device of claim 15, wherein the processor is further configured to, based on the vehicle drive being determined to be possible by using only the battery output in the current driving segment, compare the required fuel cell output value of the current driving segment and a determined fuel cell power generation demand during the vehicle drive.

According to an example of the device of the present disclosure, the device of claim 16, wherein the processor is further configured to, based on the required fuel cell output value of the current driving segment being smaller, limit the fuel cell power generation even if battery discharge is performed in the current driving segment.

According to an example of the device of the present disclosure, the device of claim 15 or claim 16, wherein the processor is further configured not to limit the fuel cell power generation when the battery discharge of the vehicle in the current driving segment is performed up to or above a predetermined criterion.

According to an example of the device of the present disclosure, the device of claim 17, wherein the processor is further configured to, based on the fuel cell power generation being limited, discharge a battery SOC by using only the battery output during the vehicle drive in the current driving segment, even if the first upcoming driving segment and the second upcoming driving segment are longer than a threshold distance and a downhill.

According to an example of the device of the present disclosure, the device of claim 18, wherein based on the fuel cell power generation not being limited, the fuel cell power generation is controlled during the vehicle drive in the current driving segment to charge or discharge the battery SOC according to the first upcoming driving segment and the second upcoming driving segment.

The effects obtainable from the present disclosure are not limited to the above-mentioned effects, and other effects not mentioned herein will be clearly understood by those skilled in the art through the following descriptions.

According to the present disclosure, it is possible to provide a method and device for controlling fuel cell power generation of a vehicle by dividing an upcoming driving segment into at least a first upcoming driving segment and a second upcoming driving segment and accurately predicting an expected battery output value required for each segment based on upcoming driving information of each segment acquired from a peripheral device of the vehicle.

According to the present disclosure, it is possible to provide a method and device for controlling fuel cell power generation of a vehicle by dividing an upcoming driving segment into at least two segments, that is, a first upcoming driving segment and a second upcoming driving segment, calculating an expected battery charge/discharge output value, and performing motor drive only with a battery output, even while the vehicle is operating in a current driving segment, and limiting fuel cell power generation in order to sufficiently secure a battery SOC to be charged.

According to the present disclosure, it is possible to maintain regenerative braking for a longer time than a threshold time during longer than a threshold distance downhill driving by limiting fuel cell power generation before an upcoming driving segment, which is expected to be downhill, reducing a power generation amount and thus sufficiently discharging a battery SOC in advance.

That is, when upcoming driving information is obtained for each segment of at least two or more upcoming driving roads, as the present disclosure is applied, if a first upcoming driving road and a second upcoming driving road are longer than a threshold distance and a downhill and battery SOC charge is expected, fuel cell power generation control may be limited, and EV driving may be performed only using a battery output. Thus, it is possible to sufficiently secure a battery SOC that will be charged by regenerative braking in a downhill upcoming driving segment. Accordingly, as regenerative braking may be maintained for a longer time than a threshold time during a downhill driving, the performance of a vehicle may be improved during downhill driving, and the overall performance of fuel cells and the vehicle may be expected.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative examples of the present disclosure. Examples or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed:

1. A method for controlling power generation of a fuel cell of a vehicle, the method comprising:
obtaining driving information about an upcoming segment of a road to be driven by the vehicle driving on a current segment of the road;
determining, based on the driving information, a required fuel cell output value of the current segment;
determining, based on the driving information and the required fuel cell output value, whether to limit power generation of the fuel cell; and
controlling, based on the determining, reduction of power generation of the fuel cell such that a power supply for driving the vehicle in the current segment is provided from a battery of the vehicle.

2. The method of claim 1, wherein the driving information comprises information about the current segment and the upcoming segment, and wherein the upcoming segment comprises a first upcoming segment of the road, and a second upcoming segment of the road.

3. The method of claim 2, wherein the determining the required fuel cell output value of the current segment further comprises:
estimating an expected battery output value;
estimating an expected battery charge/discharge energy demand by multiplying the expected battery output value and an expected future driving time for the first upcoming segment and the second upcoming segment;
estimating a required battery charge/discharge output value of the current segment by dividing the expected battery charge/discharge energy demand by an expected current driving time for the current segment; and
determining the required fuel cell output value of the current driving segment based on a sum of the required battery charge/discharge output value of the current segment and a required vehicle output value for driving of the vehicle.

4. The method of claim 3, wherein the determining the required fuel cell output value of the current segment comprises adjusting the required battery charge/discharge output value based on the required vehicle output value for the driving of the vehicle.

5. The method of claim 1, wherein the determining whether to limit power generation of the fuel cell further comprises determining whether driving the vehicle in the current segment is possible using power supplied solely from the battery by comparing a battery discharge output limit value and a determined electric vehicle (EV) drivable battery discharge output value.

6. The method of claim 5, further comprising, based on a determination that the driving the vehicle in the current segment is possible using power supplied solely from the battery, comparing the required fuel cell output value of the current segment and a determined fuel cell power generation demand during the driving of the vehicle.

7. The method of claim 6, wherein, based on the required fuel cell output value of the current segment being smaller than the determined fuel cell power generation demand, power generation of the fuel cell is limited while battery discharge occurs for the driving the vehicle in the current segment.

8. The method of claim 5, wherein, based on a battery discharge amount for driving the vehicle in the current segment exceeding a predetermined threshold, power generation of the fuel cell is allowed.

9. The method of claim 7, wherein, based on the power generation of the fuel cell being limited, the battery is discharged by using power supplied solely from the battery for the driving the vehicle in the current segment, wherein a first upcoming segment of the upcoming segment and a second upcoming segment of the upcoming segment are longer than a threshold distance and a downhill.

10. The method of claim 8, wherein, based on the power generation of the fuel cell being allowed, power generation of the fuel cell is controlled for driving the vehicle in the current segment to charge or discharge the battery based on a first upcoming segment of the upcoming segment and a second upcoming segment of the upcoming segment.

11. An apparatus for controlling power generation of a fuel cell of a vehicle, the apparatus comprising:
a peripheral device configured to obtain driving information comprising at least one of:
a vehicle speed limit of an upcoming segment of a road to be driven by the vehicle driving on a current segment of the road, or
a presence of a gradient and gradient-related data;
a processor; and
a memory storing at least one instruction that, when executed by the processor, is configured to cause the apparatus to:
determine, based on the driving information, a required fuel cell output value of the current segment,
determine, based on the driving information and the required fuel cell output value of the current segment, whether to limit power generation of the fuel cell; and
control, based on the determination, reduction of power generation of the fuel cell such that a power supply for driving the vehicle in the current segment is provided from a battery of the vehicle.

12. The apparatus of claim 11, wherein the driving information comprises information about the current segment and the upcoming segment, and wherein the upcoming segment comprises a first upcoming segment of the road, and a second upcoming segment of the road.

13. The apparatus of claim 12, wherein the at least one instruction, when executed by the processor, is further configured to cause the apparatus to:
determine the required fuel cell output value of the current segment by:
estimating an expected battery output value,
estimating an expected battery charge/discharge energy demand by multiplying the expected battery output value and an expected future driving time for the first upcoming segment and the second upcoming segment, and
estimating a required battery charge/discharge output value of the current segment by dividing the expected battery charge/discharge energy demand by an expected current driving time for the current segment; and
determine the required fuel cell output value of the current driving segment based on a sum of the required battery charge/discharge output value of the current segment and a required vehicle output value for driving of the vehicle.

14. The apparatus of claim 13, wherein the at least one instruction, when executed by the processor, is further configured to cause the apparatus to determine the required fuel cell output value of the current segment by adjusting the required battery charge/discharge output value based on the required vehicle output value for driving of the vehicle.

15. The apparatus of claim 11, wherein the at least one instruction, when executed by the processor, is further configured to cause the apparatus to determine whether to limit power generation of the fuel cell by determining whether driving the vehicle in the current segment is possible using power supplied solely from the battery by comparing a battery discharge output limit value and a determined electric vehicle (EV) drivable battery discharge output value.

16. The apparatus of claim 15, wherein the at least one instruction, when executed by the processor, is further configured to cause the apparatus to, based on a determination that the driving the vehicle in the current segment is possible using power supplied solely from the battery, compare the required fuel cell output value of the current segment and a determined fuel cell power generation demand during the driving of the vehicle.

17. The apparatus of claim 16, wherein the at least one instruction, when executed by the processor, is further configured to cause the apparatus to, based on the required fuel cell output value of the current segment being smaller than the determined fuel cell power generation demand, limit power generation of the fuel cell while battery discharge occurs for the driving the vehicle in the current segment.

18. The apparatus of claim 15, wherein the at least one instruction, when executed by the processor, is further configured to cause the apparatus, to allow power generation of the fuel cell based on a battery discharge amount for driving the vehicle in the current segment exceeding a predetermined threshold.

19. The apparatus of claim 17, wherein the at least one instruction, when executed by the processor, is further configured to cause the apparatus to, based on the generation of the fuel cell being limited, discharge the battery by using power supplied solely from the battery for the driving the vehicle in the current segment, wherein a first upcoming segment of the upcoming segment and a second upcoming segment of the upcoming segment are longer than a threshold distance and a downhill.

20. A vehicle comprising:
one or more sensors configured to obtain gradient information about an upcoming segment of a road to be driven by the vehicle driving on a current segment of the road;
a fuel cell;
a battery;
a processor; and
a memory storing at least one instruction that, when executed by the processor, is configured to cause the vehicle to:
determine, based on the gradient information, an expected regenerative charging amount of the battery associated with the upcoming segment;
determine, based on the expected regenerative charging amount and a required fuel cell output value of the current segment, to limit power generation of the fuel cell; and
control, based on the determination to limit power generation of the fuel cell, reduction of power generation of the fuel cell such that a power supply for driving the vehicle in the current segment is provided from the battery while power generation of the fuel cell is limited.
